(19) United States
(12) Patent Application Publication
(10) Pub. No.: US 2014/0191521 A1
(43) Pub. Date: Jul. 10, 2014

(54) Mortar Shovel

(71) Applicant: German Cantu, San Antonio, TX (US)

(72) Inventor: German Cantu, San Antonio, TX (US)

(21) Appl. No.: 14/146,210

(22) Filed: Jan. 2, 2014

Related U.S. Application Data
(60) Provisional application No. 61/748,960, filed on Jan. 4, 2013.

(51) Int. Cl. A01B 1/02

(52) U.S. Cl. CPC A01B 1/02
USPC 294/57

(57) ABSTRACT

A shovel comprising an elongate handle having two ends, a first section, a second section aligned with and spaced from the first section, a third section connected between the first section and the second section, the elongate handle forming an intermediate grip opening in a first direction; a shovel head connected to one end of the elongate handle. An embodiment of the present invention includes a blade having a concave surface having a surface area and opening in a second direction generally opposite the first direction, and a convex surface opposing the concave surface. In this alternative embodiment, the blade has a plurality of holes extending between the concave surface and the convex surface; and wherein the ratio of the size of all of the openings to the surface area of the concave surface is twenty-five percent.

### CROSS-REFERENCES TO RELATED APPLICATIONS

This is an original nonprovisional application that claims the benefit of and priority to U.S. provisional application Ser. No. 61/748,960, filed Jan. 4, 2013, which is incorporated by reference.

### STATEMENT REGARDING FEDERALLY SPONSORED RESEARCH OR DEVELOPMENT

Not applicable.

### BACKGROUND

1. Field of the Invention

The invention relates to the field of hand tools or implements. More specifically, the invention relates to a concrete mixing shovel for the mixing of a liquid with dry concrete/pre-mix.

2. Description of the Related Art

Shovels come in different shapes and styles. Every shovel, however, has a head and handle that extends from the head, although the shape and style of shovels widely depend on intended use. Nonetheless, the same action is put into play every time a shovel is used: the head is plunged into some material to be either moved or mixed.

In the construction field, the common practice of mixing a powder with liquid (e.g., making cement) is usually placing the dry powder in a large container (e.g., a wheelbarrow) and forming a heap, adding the liquid, usually water, and mixing the liquid with the powder. The process is continued until the desired consistency is reached.

While standard shovels and mortar hoes might be convenient and adequate tools for mixing, these tools suffer from many drawbacks and limitations. For example, people have difficulty mixing such materials with these tools and have a tendency to add extra liquid to the mix to ease the process of mixing such materials, which results in a loose pasty mix rather than a mix of optimal consistency.

In any event, when the desired consistency is reached, the mixer might encounter yet another problem: getting the last powder remnants from the bottom, sides, ends, and corners of the container where powder might have coagulated and sunk to the bottom adhering to the container surfaces. In this case, the mixer will use more than average force (compared to simply removing slurry from the middle of the container) to reach these areas and have difficulty breaking the clots up in order to reach the desired consistency.

Moreover, this manual action of shoveling and mixing constantly puts a great deal of strain on certain muscle groups, specifically the back and arms. As a result, individuals frequently strain muscles in these groups when using a standard shovel or hoe/mortar hoe.

### SUMMARY OF PREFERRED EMBODIMENTS

The present invention is a shovel comprising an elongate handle having two ends, a first section, a second section aligned with and spaced from the first section, a third section connected between the first section and the second section, with the elongate handle forming an intermediate grip opening in a first direction; a shovel head connected to one end of the elongate handle. An embodiment of the present invention includes a blade having a concave surface with a surface area and opening in a second direction generally opposite the first direction, and a convex surface opposing the concave surface. In this alternative embodiment, the blade has a plurality of holes extending between the concave surface and the convex surface; and wherein the ratio of the aggregate size of all openings to the surface area of the concave surface is approximately twenty-five percent.

### BRIEF DESCRIPTION OF THE SEVERAL VIEWS OF THE DRAWINGS

FIG. 1 is a front elevation of an embodiment of the invention.

FIG. 2 is a side elevation of the embodiment shown in FIG. 1.

### DETAILED DESCRIPTION OF VARIOUS EMBODIMENTS

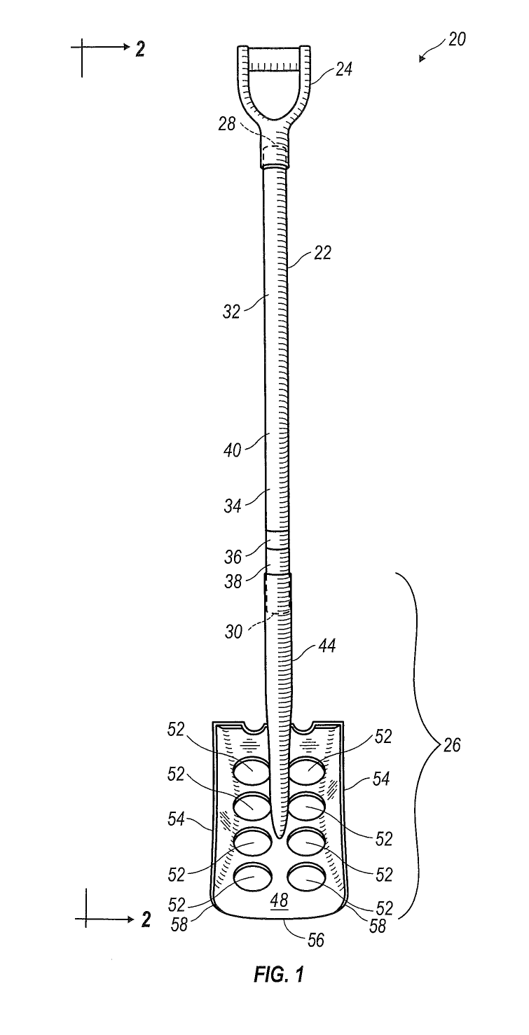

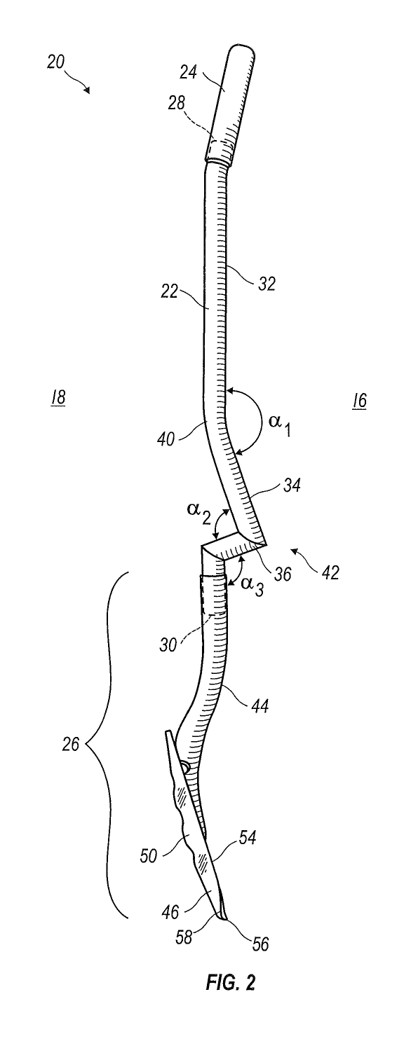

FIGS. 1-2 show an embodiment 20 of the present invention described with reference to a front direction 16 and a rear direction 18. The embodiment 20 comprises a handle 22, an end grip 24, and a shovel head 26.

The handle 22 is an irregularly-shaped elongate member having a first end 28 received by the grip 24 and a second end 30 received by the shovel head 26. The handle 22 includes a first straight section 32, a second straight section 34 joined to the first straight section 32, a third straight section 36 joined to the second straight section 34, and a fourth straight section 38 joined to the third section 36 and co-terminating with the second end 30. The handle 22 is hollow and each section thereof is generally tubular. In this embodiment, the handle 22 is a metal (e.g., aluminum) having one-fourteenth inch outer diameter.

As used herein, “joined” means that the one section is in a fixed relationship relative to the other section when unstressed (other than bending of a section during normal use), although the junction may be directly section-to-section, as shown between the third straight section 36 and the fourth straight section 38, which are welded directly to one another, or may have an intermediate section, such as a curved section, between the joined sections. For example, a curved section 40 joins the first section 32 to the second section 34.

The second straight section 34 is angled at an angle α₁ from the first straight section 32. The third straight section 36 is angled at an angle α₂ from the second straight section 34. The fourth straight section 38 is angled at an angle of α₃ from the third straight section 36. In this embodiment, α₁ is one-hundred sixty three degrees, α₂ is ninety degrees, and α₃ is one-hundred seven degrees.

The fourth straight section 38 and first straight section 32 are parallel and axially aligned. The junction between the second and third straight sections 34, 36 forms an intermediate grip 42 extending forward of the axis of the first and fourth sections 32, 38. The intermediate grip 42 is longitudinally between the first end 28 and the second end 38 that is closer to the shovel head 26 than the end grip 24. The intermediate grip 42 opens to the rear side of the shovel 22.

The shovel head 26 is fixed to the second end 30 of the handle 22. The head 26 is a single metallic piece (e.g., tempered steel) that includes a tubular section 44 for receiving the handle 22 and a blade 46 extending from the tubular section 44. As shown in FIG. 1, the blade 44 has a concave surface 48 opposing a convex second surface 50. Eight ovular holes 52 extend between first and second surfaces 48, 50. While shown with ovular openings, the openings may be of any shape. The tubular section 44 narrows in diameter toward, and is attached to, the concave surface 48

Opposing sides 54 of the blade 46 are curved and parallel to the second straight section 34. The sides 54 are joined to a generally straight bottom edge 56 of the blade 46 with rounds 58.

In the preferred embodiment, the holes 52 are aligned in two columns of four rows each, and are identically sized. The preferred length of the major axis of the holes is two and-a-half inches, and the preferred length of the minor axis diameter of the holes 52 is one-and-a-half inches. The ratio of the area of all of the holes 52 to the concave surface 48 is twenty-five percent. This ratio includes the “portion” of the concave surface 48 attached to the tubular section 44 and not exposed to material because of this attachment. In other embodiments, the ratio may be between twenty percent and thirty percent.

During use of the embodiment 20, the features described above provide at least the following benefits to the user. The curved sides 54 of the blade 46 enhance the user's ability to slide the blade 46 along the bottom of a wheelbarrow or like container to scoop material near the wheelbarrow surface. Rounds 58 facilitate sliding the blade 46 at the bottom of containers.

The holes 52 allow the blade 46 to be drawn back and forth by the user when mixing such materials. The ratio of the size of all of the hole openings 52 to the concave surface 48 allows material to easily flow through the blade 46 rather than being pushed to the edges and around the blade 46 while still having sufficient surface area to effectively remove material from the mixing container.

In addition, material and liquid mix as it flows through the holes 52, diminishing the mixing time normally required by use of solid-head shovels and resulting in more uniformly-mixed slurry. In one experiment, the inventor determined that the embodiment described herein reduced standard mixing time by approximately fifty percent by lifting and shaking the material with the shovel and allowing it to fall through the holes and down to the container.

The intermediate grip 42 provides a more ergonomic position for a hand during use. The positioning of the grip 42 allows the corresponding arm to be less extended from the body when lifting, pushing or pulling relative to conventional shovel handle.

The present disclosure includes preferred or illustrative embodiments in which specific tools are described. Alternative embodiments of such tools can be used in carrying out the invention as claimed and such alternative embodiments are limited only by the claims themselves. Other aspects and advantages of the present invention may be obtained from a study of this disclosure and the drawings, along with the appended claims.

I claim:

1. A shovel having a front and a rear, the shovel comprising:
an elongate handle having two ends, a first section, a second section aligned with and spaced from the first section, a third section connected between the first section and the second section, the elongate handle forming an intermediate grip opening toward the rear;
a shovel head connected to one end of the elongate handle.

2. The shovel of claim 1 wherein the shovel head comprises:
a blade having a concave surface having a surface area and opening in a second direction generally opposite the first direction, and a convex surface opposing the concave surface;
wherein the blade has a plurality of holes extending between the concave surface and the convex surface; and
wherein the ratio of the size of all of the openings to the surface area of the concave surface is between twenty percent and thirty percent.

3. A shovel having a front and a rear, the shovel comprising:
an elongate handle having two opposing ends;
a shovel head connect to one end of the elongate handle, the head comprising a blade having a concave surface and an opposing convex surface and a plurality of holes extending between the concave and convex surfaces,
wherein the ratio of the size of all openings to the surface area of the concave surface is between twenty percent and thirty percent.

4. The shovel of claim 3 wherein the handle forms an intermediate grip between the two opposing ends of the handle, said intermediate grip opening to the rear.
